(19) United States
(12) Patent Application Publication
(10) Pub. No.: US 2015/0051911 A1
(43) Pub. Date: Feb. 19, 2015

(54) METHOD FOR DIVIDING LETTER SEQUENCES INTO PRONUNCIATION UNITS, METHOD FOR REPRESENTING TONES OF LETTER SEQUENCES USING SAME, AND STORAGE MEDIUM STORING VIDEO DATA REPRESENTING THE TONES OF LETTER SEQUENCES

(71) Applicant: Byoung Ki CHOI, (US)

(72) Inventor: Byoung Ki Choi, Daejeon (KR)

(21) Appl. No.: 14/387,841

(22) PCT Filed: Apr. 3, 2013
(86) PCT No.: PCT/KR2013/002764

§ 371 Date: Sep. 25, 2014

(30) Foreign Application Priority Data
Apr. 13, 2012 (KR) 10-2012-0038741

(51) Int. Cl. G10L 15/08; G06F 17/20

(52) U.S. Cl. CPC G10L 15/08; G06F 17/20
USPC 704/253

(57) ABSTRACT

Disclosed is a method for dividing pronunciation units which includes the steps of: extracting voice-intensity maxima and minima in voice waveforms of letter sequences; forming a group by grouping the extracted maxima together; dividing the letter sequences into pronunciation units around the points nearest to either side of the group from among minima on both sides of the group, voice start points, and voice end points.

### CROSS REFERENCE TO PRIOR APPLICATIONS

This application is a National Stage Application of PCT International Patent Application No. PCT/KR2013/002764 filed on Apr. 3, 2013, under 35 U.S.C. §371, which claims priority to Korean Patent Application No. 10-2012-0038741 filed on Apr. 13, 2012, which are all hereby incorporated by reference in their entirety.

### BACKGROUND

1. Field

The present invention relates to a method for dividing a letter sequence into pronunciation units, a method for representing a tone of the letter sequence using the same, and a storage medium storing video data representing the tone of the letter sequence, and more particularly, to a method for dividing a letter sequence into pronunciation units such that tone data may be extracted to represent a tone of the letter sequence, a method for representing the tone of the letter sequence by changing a letter attribute within a video frame in which the letter sequence is displayed on the basis of the tone data extracted for each pronunciation unit, and a storage medium storing video data representing the tone of the letter sequence.

2. Description of Related Art

In the related art, there exists a method of controlling a size of a letter corresponding to sound source data depending on whether the frequency of the sound that is implemented by the sound source data is high or low.

In addition, there exists a method for varying a height of the letter depending on the strength or weakness of pronunciation, such that voice information that is added to a letter sequence may be intuitively recognized.

Furthermore, there exists a method for adding attribute data to letter data such that contents, emotions, or moods may be exposed well in a displayed text sentence.

Patent document 1 entitled “AUDIO PLAYER CAPABLE OF ADJUSTING LETTERS IN SIZE AND CONTROLLING METHOD THEREOF” discloses an apparatus and method that visually check a tempo and a height of a letter sequence at the same time by comparing a frequency of a sound that is implemented by sound source data with a first reference frequency and a second reference frequency to classify the sound into a high frequency sound, a middle frequency sound, and a low frequency sound and displaying a letter corresponding to the sound source data in a small, medium, or large size depending on whether the sound corresponds to the high frequency sound, the middle frequency sound, and the low frequency sound in order to improve a problem in which it is not possible to check the height of audio information that is played back through an audio player having an audio letter display function and a tempo display function added thereto.

Patent document 2 entitled “AUDIO INFORMATION DISPLAY APPARATUS” discloses an apparatus that may intuitively recognize the pronunciation when the letter sequence is read, by changing a color, a position, a shape, and the like of the letter to represent pronunciation information, in order to solve a problem in which it is difficult to intuitively understand a height, a strength, and a pose of the pronunciation because the height, the strength, and the pose of the pronunciation are conventionally represented by special symbols.

Patent document 3 entitled “TEXT SENTENCE DISPLAY APPARATUS” discloses an apparatus that may effectively deliver emotions or moods of a text sentence writer by adding attribute data, such as a position, a size, a thickness, a font, a concentration, a color, and an outline, to the letter according to expressions or emotions of the text sentence writer or adding temporal attribute data, such as flickering, a change in size, rotation, a change in concentration, and a change in color, to the text in order to solve a problem in which it is not possible to clearly understand the intention of the writer in the text sentence that is represented as a conventional simple letter sequence.

However, in the related art, since attributes for visually representing a letter (hereinafter referred to as letter attributes), such as a height, a line thickness, a size, a color, a position, and a shape, are changed on a letter basis, it cannot be known how a tone changes for each unit in which a letter sequence is actually pronounced (hereinafter referred to as a pronunciation unit).

In addition, since one letter is represented as being fixed at a set letter attribute, the tone cannot be accurately represented even when the tone is changed while the letter is pronounced.

### PRIOR ART DOCUMENTS

### Patent Documents

[Patent Document 0001] KR 10-2008-0016183A (Feb. 21, 2008)

[Patent Document 0002] JPA H08-179789A (Dec. 26, 1996)

[Patent Document 0003] JPA 2005-215888A (Aug. 11, 2005)

### SUMMARY

The present invention is designed to solve the above problems, and therefore it is an object of the present invention to provide a method of dividing a letter sequence into pronunciation units and extracting data that may represent a tone for each pronunciation unit.

It is also an object of the present invention to provide a method of naturally representing a tone of a letter or letter sequence by changing a letter attribute for each frame in a video in which the letter sequence is displayed by the extracted data.

A method of dividing a letter sequence into pronunciation units according to the present invention in order to solve the above problems includes the steps of: extracting maximum points and minimum points of voice intensity from a voice waveform of the letter sequence; grouping the extracted maximum points to form a group, and dividing the letter sequence into the pronunciation units using a point nearest to either side of the group from among the minimum points, a voice start point, and a voice end point as a boundary.

In addition, a method of representing a tone of a letter sequence according to the present invention includes the steps of: dividing the letter sequence into pronunciation units using the above-described method for dividing the letter sequence into pronunciation units; extracting representative tone data for each divided pronunciation unit; calculating tone data for each video frame from the extracted representative tone data and assigning a letter attribute to each video frame; and playing back the video frame having the letter attribute assigned thereto as a video.

The method of dividing a letter sequence into pronunciation units, the method of representing a tone of the letter sequence using the division method, and the storage medium for storing video data that represents the tone of the letter sequence according to the present invention may divide the letter sequence into pronunciation units to represent the tone for each pronunciation unit.

In addition, the tone of the letter sequence may be naturally represented by changing a letter attribute that is displayed as a video in units of frame.

### BRIEF DESCRIPTION OF THE DRAWINGS

FIG. 1 is a flowchart of a method of dividing a letter sequence into pronunciation units and a method of representing a tone of the letter sequence using the division method.

FIG. 2 is an exemplary diagram of a result that is obtained by approximating a voice waveform in the present invention.

FIG. 3 is an exemplary diagram of a voice intensity pattern when the letter sequence is pronounced.

FIG. 4 is an exemplary diagram showing division into pronunciation units according to a relation between a specific maximum point and another adjacent maximum point.

FIG. 5 is a result diagram showing an example in which the voice intensity pattern of FIG. 3 is divided into three pronunciation units.

FIG. 6 is an exemplary diagram showing cases in which voice pitch is changed in a pronunciation unit.

FIG. 7 is an exemplary diagram showing an example in which an attribute is assigned to a letter according to voice intensity and voice pitch.

### DETAILED DESCRIPTION

A method of dividing a letter sequence into pronunciation units, a method of representing a tone of the letter sequence using the division method, and a storage medium for storing video data that represents the tone of the letter sequence according to the present invention will be described in detail below with reference to the accompanying drawings.

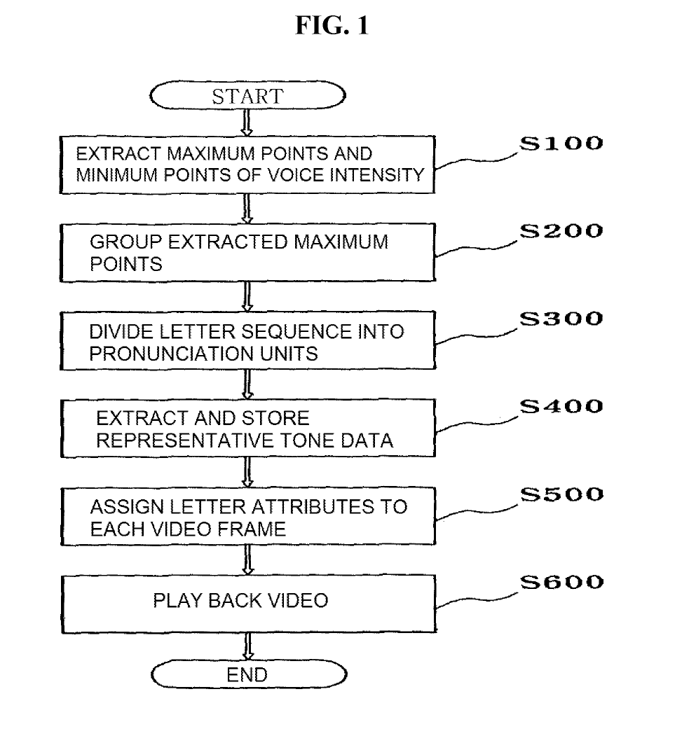

FIG. 1 is a flowchart showing a method of dividing a letter sequence into pronunciation units and a method of representing a tone of the letter sequence using the division method.

The method of dividing the letter sequence into the pronunciation units and the method of representing the tone of the letter sequence using the division method include extracting maximum points and minimum points of voice intensity from a voice waveform of the letter sequence (S100), forming a group by grouping the extracted maximum points together (S200), dividing the letter sequence into pronunciation units around the points nearest to either side of the group from among minimum points on both sides of the group, voice start points and voice end points (hereinafter referred to as minimum points and the like) (S300), extracting representative tone data for each pronunciation unit (S400); calculating tone data for each video frame from the extracted representative tone data and assigning a letter attribute to each video frame (S500); and playing back the video frame having the letter attribute assigned thereto as a video (S600).

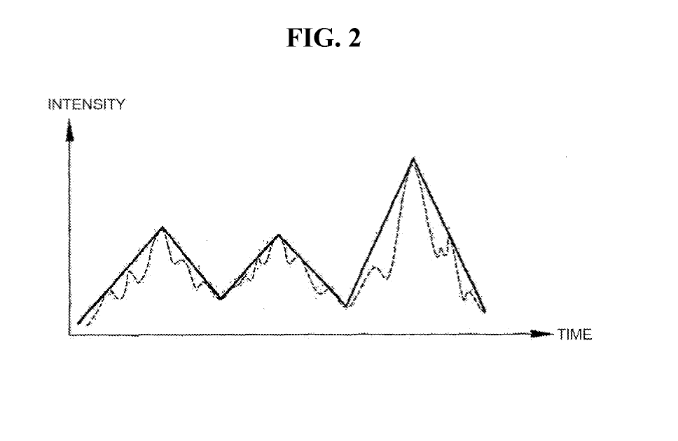

FIG. 2 is an exemplary diagram of a result that is obtained by approximating a voice waveform in the present invention. When pronunciation of a letter sequence is measured, a jagged voice intensity waveform may be obtained as indicated in a dotted line. In order to represent a tone of a letter sequence, a divided sound waveform is easier to analyze than a continuous voice waveform. Accordingly, the letter sequence needs to be divided according to a predetermined criterion. However, since all humans typically feel that pronunciation is separated when the pronunciation is stopped during a certain time or more or when voice intensity is sharply changed, and feel that the pronunciation is continued when a prolonged sound or voice intensity is gently changed, it is natural to divide a letter sequence into pronunciation units in order to represent a tone of the letter sequence.

There may be several methods that are used to divide the letter sequence into the pronunciation units. However, a technical spirit of the method of dividing the letter sequence into the pronunciation units according to the present invention is to divide the letter sequence into pronunciation units by approximating a voice waveform to a broken line having crests and troughs. Here, since the broken line having crests and troughs is a line including a group of triangles each composed of one maximum point and two minimum points on both sides thereof, the one maximum point and the two minimum points may be extracted in order to divide the letter sequence into the pronunciation units.

According to the present invention, one or more pronunciation units, each of which is formed by extracting the one maximum point and the two minimum points on both sides thereof, may be continuously arranged to represent a tone of the letter sequence, thereby finally providing video data that may represent the tone of the letter sequence.

The method of dividing the letter sequence into the pronunciation units and the method of representing the tone of the letter sequence using the division method according to the present invention will be described in detail below on a step-by-step basis.

1) Step of Extracting Maximum Points and Minimum Points of Voice Intensity in a Voice Waveform of the Letter Sequence (S100)

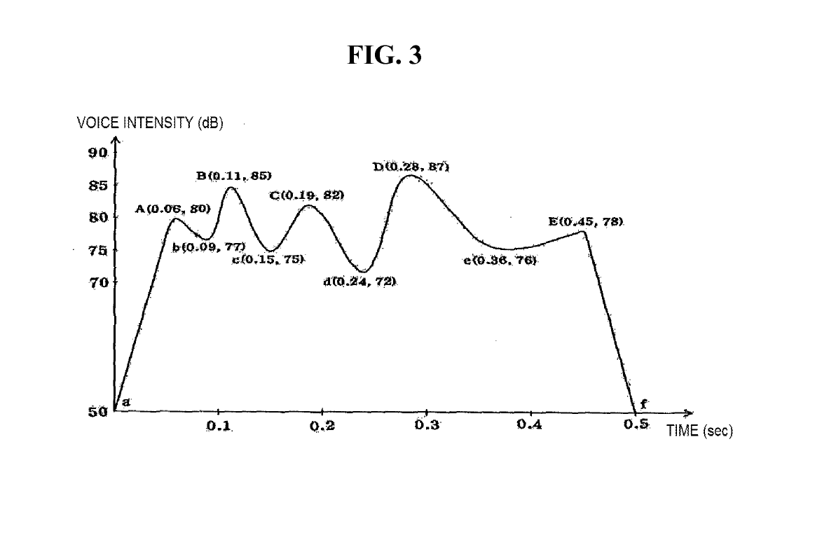

FIG. 3 is an exemplary diagram of a voice intensity pattern when the letter sequence is pronounced. Points in which the voice intensity value is maximum or minimum may be found from the voice intensity pattern. As an example of FIG. 3, the voice intensity has maximum values of 80 dB, 85 dB, 82 dB, 87 dB, and 78 dB at times of 0.06 sec, 0.11 sec, 0.19 sec, 0.28 sec, and 0.45 sec, respectively, and has minimum values of 77 dB, 75 dB, 72 dB, and 76 dB at times of 0.09 sec, 0.15 sec, 0.24 sec, and 0.36 sec, respectively.

2) Step of Grouping the Extracted Maximum Points (S200)

However, all humans do not feel that the voice intensity is changed when the pronunciation is changed at very short intervals or when the pronunciation is not changed beyond a specific level. Accordingly, when the pronunciation is changed at very short intervals or when the pronunciation is not changed beyond the specific level, one maximum value that is represented by grouping adjacent maximum values is enough to represent a change in tone.

Accordingly, the method of dividing the letter sequence into the pronunciation units and the method of representing the tone of the letter sequence using the division method according to the present invention groups a specific maximum point of the voice intensity and another maximum point adjacent to the specific maximum point to have a greater value between the maximum values as a representative value of the group when a time interval between the specific maximum point and the other adjacent maximum point is less than a predetermined time t1.

In addition, in a case in which the time interval between the specific maximum point and the other adjacent maximum point is equal to or more than t1 and less than t2, the specific maximum point and the other adjacent maximum point are grouped to have a greater value between the maximum values as a representative value of the group when a difference in maximum values between the specific maximum point and the other adjacent maximum point is less than a predetermined level of 1 dB, and the specific maximum point and the other adjacent maximum point are put in respective groups and the maximum values of the specific maximum point and the other adjacent maximum point are representative values of the respective groups when the difference in maximum values between the specific maximum point and the other adjacent maximum point is equal to or more than the predetermined level of 1 dB.

In addition, when the time interval between the specific maximum point and the other adjacent maximum point is equal to or greater than the predetermined time t2, the specific maximum point and the other adjacent maximum point are in respective groups and the maximum values of the specific maximum point and the other adjacent maximum point are representative values of the respective groups.

3) Step of Dividing the Letter Sequence into Pronunciation Units Around the Points Nearest to Either Side of the Group from Among Minimum Points on Both Sides of the Group (S300)

When the maximum points are grouped, the letter sequence is divided into the pronunciation units around the points nearest to either side of the group from among minimum points, voice start point, and voice end point on both sides of the group. Each of the pronunciation units is always in a triangle in a voice intensity graph, and the divided pronunciation units are gathered to represent a tone of the letter sequence.

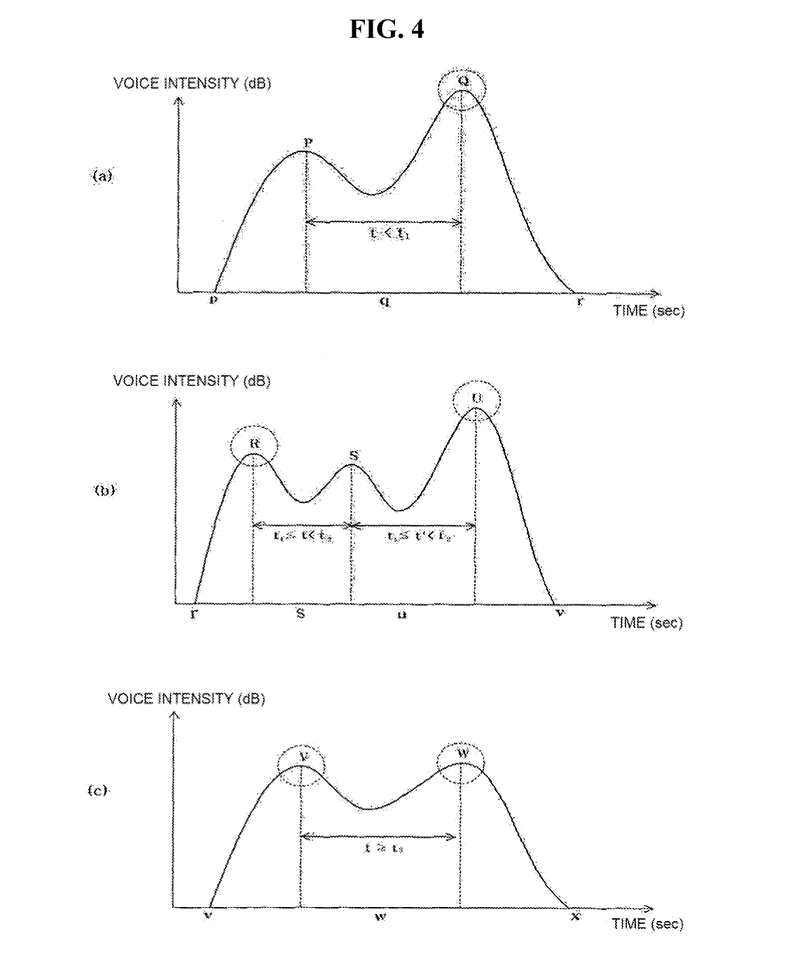

FIG. 4 is an exemplary diagram showing division into pronunciation units according to a relation between a specific maximum point and another adjacent maximum point.

FIG. 4(a) shows an example in which a time interval between two maximum points P and Q is less than t1. A value of the maximum point Q that is greater than that of the maximum point P is a representative value of the group, and the minimum points p and r on the both sides of P and Q are a voice start point and a voice end point of the pronunciation unit, respectively.

FIG. 4(b) shows an example in which both a time interval between the maximum points R and S and a time interval between the maximum points S and U are equal to or more than t1 and less than t2. A value of the maximum point R that is greater than that of the maximum point S is a representative value of the group because a difference between the maximum points R and S is less than 1 dB, and a value of the maximum point U is a representative value of a separate group because a difference between the maximum points S and U is equal to or more than 1 dB. Accordingly, in FIG. 4(b), minimum points r and u on both sides of the maximum points R and S are a voice start point and a voice end point of a first pronunciation unit, and minimum points u and v are a voice start point and a voice end point of a second pronunciation unit, respectively. That is, a voice intensity pattern such as in FIG. 4(b) is divided into two pronunciation units.

FIG. 4(c) shows an example in which a time interval between maximum points V and W is equal to or more than t2. Values of the maximum points V and W are representative values of respective groups, minimum points v and w on both sides of the maximum value V are a voice start point and a voice end point of a first pronunciation unit, respectively, and minimum points w and x on both sides of the maximum value W are a voice start point and a voice end point of a second pronunciation unit, respectively. That is, as shown in FIG. 4(c), when a time interval between the two maximum points of the voice intensity pattern is equal to or more than t2, the pronunciation unit is divided.

The case of FIG. 3 will be described again by applying detailed numerical values. When t1=0.06 sec, t2=0.10 sec, and I=3.5 dB, which are set by considering that a time in which pronunciation is lengthened and thereby cannot be stopped is about 0.06 sec, a time in which sound is identified is about 0.10 sec, and a voice intensity difference at which human being can feel a sound loudness change is about 3.5 dB, a time interval between a first maximum point A (0.06 sec, 80 dB) and a second maximum point B (0.11 sec, 85 dB) is 0.05 sec, which is less than t1, a value of the maximum point B (0.11 sec, 85 dB) that is greater than that of first maximum point A (0.06 sec, 80 dB) is a representative value of a first group. Next, a time interval between the second maximum point B (0.11 sec, 85 dB) and a third maximum point C (0.19 sec, 82 dB) is 0.08 sec, which is equal to or greater than t1 and less than t2, and a difference between the two maximum values is 3 dB, which is less than I. Thus, the maximum point B (0.11 sec, 85 dB) having the greater maximum value between the two maximum points is a representative value. However, the maximum point B (0.11 sec, 85 dB) is also the representative value of the first group, and thereby is a representative value of a group ABC that is formed by grouping three maximum values of A, B, and C (hereinafter, a name of a group is referred to like this). In this case, if a representative value of a group AB is different from that of a group BC, a greater representative value is the representative value of the group ABC.

A time interval between the third maximum point C (0.19 sec, 82 dB) and a fourth maximum point D (0.28 sec, 87 dB) is 0.09 sec, which is equal to or greater than t1 and less than t2, and a difference between the two maximum points is 5 dB, which is greater than I. Thus, the maximum point D (0.28 sec, 87 dB) having the greater value between the two maximum points is a representative value of a group D.

A time interval between the fourth maximum point D (0.28 sec, 87 dB) and a fifth maximum point E (0.45 sec, 78 dB) is 0.17 sec, which is equal to or greater than t2. Thus, the fifth maximum point E (0.45 sec, 78 dB) is a representative value of a group E.

In an example of the voice intensity pattern shown in FIG. 3 through the above-described process, the representative values are B (0.11 sec, 85 dB), D (0.28 sec, 87 dB), and E (0.45 sec, 78 dB). B is a representative value of the ABC group during a first period of 0 to 0.24 sec. D is a representative value of the D group during a second period of 0.24 to 0.36 sec. E is a representative value of the E group during a third period of 0.36 to 0.50 sec.

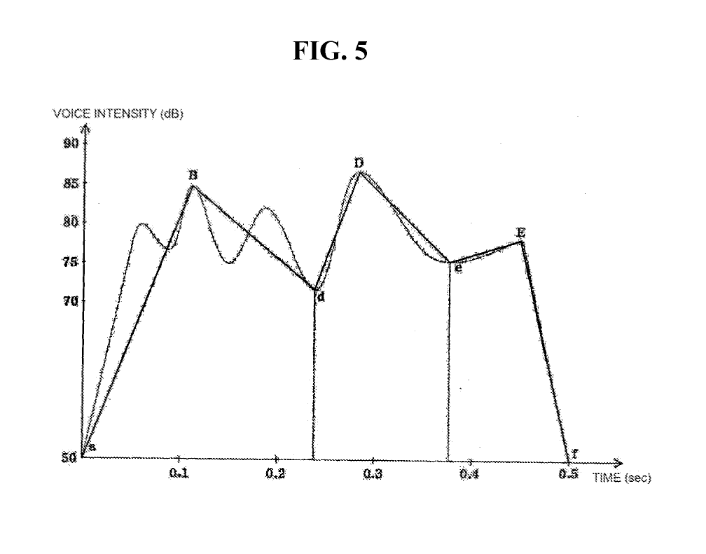

When a basic noise level without voice is 50 dB, the first period is represented as a broken line formed by connecting a voice start point a (0 sec, 50 dB), B (0.11 sec, 85 dB), and a minimum point d (0.24 sec, 72 dB), the second period is represented as a broken line formed by connecting the minimum point d (0.24 sec, 72 dB), D (0.28 sec, 87 dB), and a minimum point e (0.36 sec, 76 dB), and the third period is represented as a broken line formed by connecting the minimum point e (0.36 sec, 76 dB), E (0.45 sec, 78 dB), and a voice end point f (0.50 sec, 50 dB), as shown in FIG. 5. That is, the voice intensity pattern of FIG. 3 is divided into three pronunciation units.

In this embodiments, thought a case in which t1=0.06 sec, t2=0.10 sec, and I=3.5 dB has been described, detailed values of t1, t2, and I may be appropriately adopted to identify pronunciation units in consideration of a language, a gender difference, a speech speed, etc.

4) Step of extracting representative tone data for each pronunciation unit (S400)

When division into pronunciation units is performed, representative tone data that represents a tone is extracted for each pronunciation unit.

The representative tone data for voice intensity may be easily extracted by adopting two boundary points (minimum points and the like) and one maximum point, which are extracted for each pronunciation unit in 3) the step of dividing the letter sequence into pronunciation units around the points nearest to either side of the group from among minimum points on both sides of the group (S300).

In this case, the extracted representative tone data may be stored separately to be utilized later in 5) the step of calculating tone data for each video frame from the extracted representative tone data to assign a letter attribute for each video frame (S500).

Next, the representative tone data for voice pitch may be extracted in several cases according to the form of the voice pitch in the extracted pronunciation unit. In the voice pitch, a pattern is identified by an increase, a decrease, a decrease after an increase, and an increase after a decrease in the pronunciation unit. The voice pitch may be repeatedly increased and decreased in the pronunciation unit. However, since a time period during the extracted pronunciation unit is actually short, repeated increase and decrease may be felt as any one of the increase, the decrease, the decrease after increase, and the increase after decrease, and thereby excluded from the pattern. In addition, the voice pitch may not be measured in a period having a voiceless sound, but a similar voice pitch may be found by interpolating voice pitch values of voiced sounds before and after the voiceless sound. For the voice pitch like the voice intensity, the pattern may be identified by finding and comparing maximum points and minimum points of the voice pitch within the pronunciation unit.

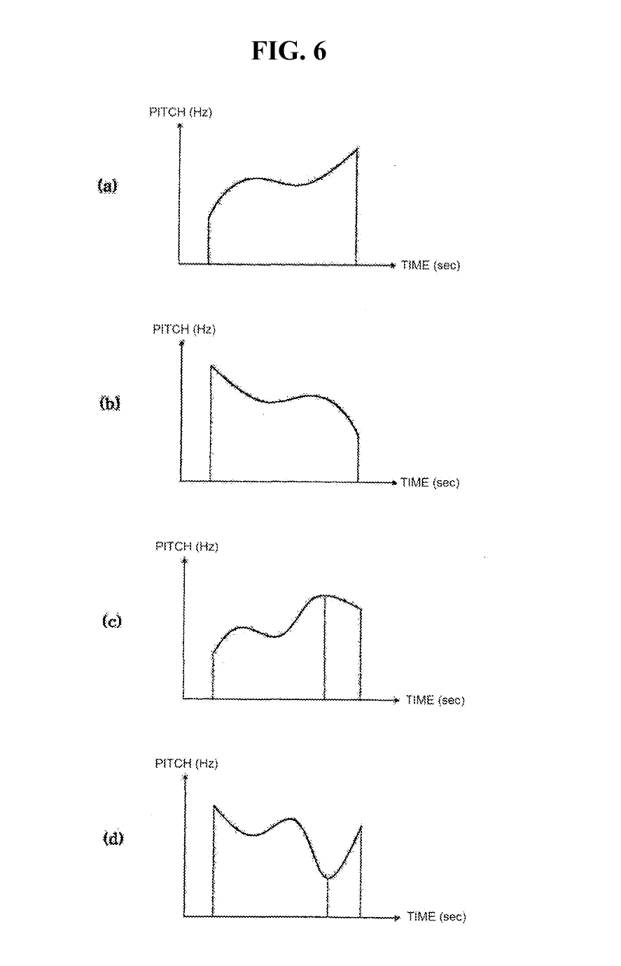

FIG. 6 is an exemplary diagram showing cases in which voice pitch changes in a pronunciation unit. FIG. 6(a) shows a case in which voice pitch increases in a pronunciation unit. In this case, a voice pitch value at a voice end point of the pronunciation unit is greater than a voice pitch value at a voice start point thereof, there is no maximum value or minimum value of the voice pitch, and even though there is a maximum value and a minimum value, the maximum value and the minimum value are greater than the voice pitch value at the voice start point and less than the voice pitch value at the voice end point. At this point, representative tone data for the voice pitch includes the voice pitch value at the voice start point of the pronunciation unit and the voice pitch value at the voice end point.

FIG. 6(b) shows a case in which voice pitch decreases in a pronunciation unit. In this case, a voice pitch value at a voice end point of the pronunciation unit is less than a voice pitch value at a voice start point thereof, there is no maximum value or minimum value of the voice pitch, and even though there is a maximum value and a minimum value, the maximum value and the minimum value are less than the voice pitch value at the voice start point and greater than the voice pitch value at the voice end point. At this point, representative tone data for the voice pitch includes the voice pitch value at the voice start point of the pronunciation unit and the voice pitch value at the voice end point. In other words, representative tone data for the voice pitch that increases or decreases includes the voice pitch value at the voice start point of the pronunciation unit and the voice pitch value at the voice end point.

FIG. 6(c) shows a case in which voice pitch increases and then decreases. In this case, a maximum of the maximum values of the voice pitch in the pronunciation unit is greater than the voice pitch value at the voice start point of the pronunciation unit and the voice pitch value at the voice end point. At this point, representative tone data for the voice pitch includes the voice pitch value at the voice start point of the pronunciation unit, the maximum of the maximum values of the voice pitch in the pronunciation unit, and the voice pitch value at the voice end point of the pronunciation unit.

FIG. 6(d) shows a case in which voice pitch decreases and then increases. In this case, a minimum of the minimum values of the voice pitch in the pronunciation unit is less than the voice pitch value at the voice start point of the pronunciation unit and the voice pitch value at the voice end point. At this point, representative tone data for the voice pitch includes the voice pitch value at the voice start point of the pronunciation unit, the minimum of the minimum values of the voice pitch in the pronunciation unit, and the voice pitch value at the voice end point of the pronunciation unit. In other words, representative tone data for the voice pitch that increases and then decreases or decreases and then increases includes the voice pitch value at the voice start point of the pronunciation unit, the voice pitch value at the voice end point, and the maximum of the maximum values of the voice pitch or the minimum of the minimum values of the voice pitch in the pronunciation unit.

If the minimum of the minimum values of the voice pitch in the pronunciation unit is less than the voice pitch value at the voice start point of the pronunciation unit and the voice pitch value at the voice end point, and the maximum of the maximum values of the voice pitch in the pronunciation unit is greater than the voice pitch value at the voice start point of the pronunciation unit and the voice pitch value at the voice end point, reference tone data for the voice pitch includes the voice pitch value at the voice start point of the pronunciation unit, the voice pitch value at the voice end point, the maximum of the maximum values of the voice pitch in the pronunciation unit, and the minimum of the minimum values of the voice pitch in the pronunciation unit.

The extracted representative tone data for each pronunciation unit is utilized in 5) the step of calculating tone data for each video frame from the extracted representative tone data to assign a letter attribute for each video frame (S500).

In this embodiment, thought a case in which the voice intensity and the voice pitch are adopted together as the representative tone data have been described, any one of the voice intensity and the voice pitch may be adopted as the representative tone data, and also any type of data may be adopted in addition to the voice intensity and the voice pitch if the type of data is an element that can represent the tone.

5) Step of calculating tone data for each video frame from the extracted representative tone data to assign a letter attribute for each video frame (S500)

The extracted representative tone data includes a time point at which the voice intensity and the voice pitch change and a value at the time point and does not include information about how a letter is represented for each video frame. Accordingly, in order to naturally representing a letter in a video according to the tone, an attribute is required to be assigned to the letter (hereinafter referred to as a corresponding letter) corresponding to the voice data according to the tone data such as the voice intensity or voice pitch for each video frame. The method for dividing a letter sequence into pronunciation units and the method for representing a tone of the letter sequence using the division method includes calculating tone data (voice intensity or voice pitch) at a time when each video frame is set by interpolation in the representative tone data and assigning an attribute to the corresponding letter in the video frame on the basis of the calculated tone data for each video frame.

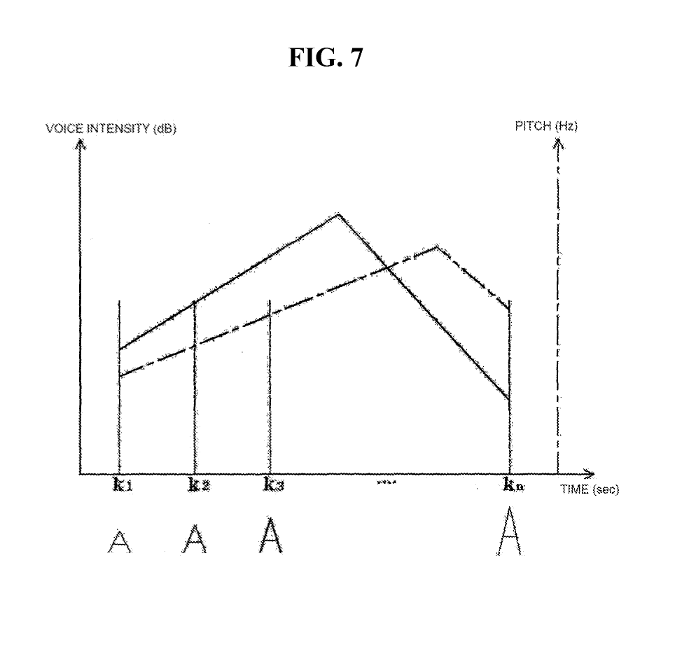

FIG. 7 is an exemplary diagram showing an example in which an attribute is assigned to a corresponding letter according to voice intensity and voice pitch. In an example of FIG. 7, the voice intensity corresponds to a line thickness of the letter, and the voice pitch corresponds to a height of the letter. It can be seen that a letter having an attribute assigned thereto is displayed such as a letter A in a lower portion of FIG. 7 by calculating a voice intensity value and a voice pitch value in each video frame k1, k2, k3, . . . , kn through interpolation in representative tone data and assigning a line thickness and height of the corresponding letter for each video frame in proportion to the calculated voice intensity value and voice pitch value. In the present embodiment, the voice intensity and the voice pitch correspond to the line thickness and height of the letter. However, the voice intensity and the voice pitch may correspond to any attribute, such as color, gradation, a width, a slope, and a magnitude (point), which can represent a change in the letter over time, in addition to the line thickness and the height.

If an attribute is assigned to the corresponding letter for each video frame using the above-described method, video data including video frame data that is image data and attribute data that represents a tone of the corresponding letter in the video frame may be stored in a storage medium and played back by a playback device. In this case, the video data may be stored including an image, a comment, voice data, metadata, etc. related to the letter sequence.

6) Step of playing back a video frame having a letter attribute assigned thereto as a video (S600)

When a letter attribute is assigned for each video frame in 5) the step of calculating tone data for each video frame from the extracted representative tone data and assigning a letter attribute to each video frame (S500) and the video frames are displayed at a certain time interval, a video in which a letter attribute (line thickness or height) naturally changes according to the tone is played back.

When playing back the video, the letter and the voice are synchronized. A method for synchronizing the letter and the voice includes a method of inserting synchronization information about a video frame into a bit stream file of a voice and synchronizing the voice and the video frame using the synchronization information and a method of dividing a voice into a voiced sound and a voiceless sound according to phonetic symbols and then synchronizing the voice and the video frame through phonological processing. However, detailed description thereof is outside the scope of the present invention, and thus will be omitted.

### DESCRIPTION OF SYMBOLS

A, B, C, D, E, P, Q, R, S, U, V, W: MAXIMUM POINT

b, c, d, e, q, s, u, w: MINIMUM POINT

### INDUSTRIAL APPLICABILITY

The method of dividing a letter sequence into pronunciation units, the method of representing a tone of the letter sequence using the division method, and the storage medium for storing video data that represents the tone of the letter sequence according to the present invention may divide the letter sequence into pronunciation units to represent the tone for each pronunciation.

In addition, the present invention may be industrially applicable since the tone of the letter sequence may be naturally represented by changing a letter attribute that is displayed as a video in units of frame.

1. A method of dividing a letter sequence into pronunciation units, the method comprising:
extracting maximum points and minimum points of voice intensity from a voice waveform of the letter sequence (S100);
grouping the extracted maximum points to form a group (S200); and
dividing the letter sequence into the pronunciation units, using a point nearest to either side of the group from among the minimum points, a voice start point, and a voice end point as a boundary (S300).

2. The method of claim 1, wherein each pronunciation unit includes one maximum value as a representative value.

3. The method of claim 2, wherein, when a time interval between a specific maximum point and another adjacent maximum point of voice intensity is less than a certain time t1 or when the time interval between the specific maximum point and the other adjacent maximum point of the voice intensity is equal to or greater than the certain time t1 and less than a certain time t2 and a difference between maximum values of the specific maximum point and the other adjacent maximum point is less than a certain level of 1 dB, the grouping of the extracted maximum points (S200) comprises grouping the specific maximum point and the other adjacent maximum point to have a greater value between the maximum values as a representative value.

4. The method of claim 2, wherein, when a time interval between a specific maximum point and another adjacent maximum point of voice intensity is equal to or greater than a certain time t2 or when the time interval between the specific maximum point and the other adjacent maximum point of the voice intensity is equal to or greater than a certain time t1 and less than the certain time t2 and a difference between maximum values of the specific maximum point and the other adjacent maximum point is equal to or greater than a certain level of 1 dB, the grouping of the extracted maximum points (S200) comprises putting the specific maximum point and the other adjacent maximum point in separate groups to have the maximum values of the specific maximum point and the other adjacent maximum point as representative values of the separate groups.

5. A method of representing a tone of a letter sequence, the method comprising:
dividing the letter sequence into pronunciation units;
extracting representative tone data for each of the divided pronunciation units (S400);
calculating tone data for each video frame from the extracted representative tone data and assigning a letter attribute to each video frame (S500); and
playing back the video frame having the letter attribute assigned thereto as a video (S600),
wherein the dividing of the letter sequence into the pronunciation units is performed according to the method of claim 1.

6. The method of claim 5, wherein the representative tone data is voice intensity or voice pitch.

7. The method of claim 6, wherein the representative tone data for the voice intensity includes two boundary points and one maximum point for each pronunciation unit.

8. The method of claim 6, wherein the representative tone data for the voice pitch includes a voice pitch value at a voice start point of the pronunciation unit and a voice pitch value at a voice end point when the voice pitch increases or decreases in the pronunciation unit and includes the voice pitch value at the voice start point, the voice pitch value at the voice end point, and a maximum of maximum values or a minimum of minimum values of the voice pitch in the pronunciation unit when the voice pitch increases and then decreases or decreases and then increases.

9. The method of claim 5, wherein the calculating of the tone data for each video frame from the extracted representative tone data and the assigning of the letter attribute to each video frame (S500) comprises calculating tone data at a time when each video frame is set by interpolation in the representative tone data and then assigning an attribute to a letter in the video frame based on the calculated tone data for each video frame.

10. The method of claim 9, wherein the attribute assigned to the letter includes any one or more of a line thickness, a height, a color, a gradation, a width, a slope, and a size.

11. The method of claim 10, wherein tone data for the voice intensity of the tone data corresponds to a line thickness of a letter and tone data for the voice pitch corresponds to a height of the letter.

12. A method of representing a tone of a letter sequence, the method comprising:
dividing the letter sequence into pronunciation units;
extracting representative tone data for each of the divided pronunciation units (S400);
calculating tone data for each video frame from the extracted representative tone data and assigning a letter attribute to each video frame (S500); and
playing back the video frame having the letter attribute assigned thereto as a video (S600),
wherein the dividing of the letter sequence into the pronunciation units is performed according to the method of claim 2.

13. A method of representing a tone of a letter sequence, the method comprising:
dividing the letter sequence into pronunciation units;
extracting representative tone data for each of the divided pronunciation units (S400);
calculating tone data for each video frame from the extracted representative tone data and assigning a letter attribute to each video frame (S500); and
playing back the video frame having the letter attribute assigned thereto as a video (S600),
wherein the dividing of the letter sequence into the pronunciation units is performed according to the method of claim 3.

14. A method of representing a tone of a letter sequence, the method comprising:
dividing the letter sequence into pronunciation units;
extracting representative tone data for each of the divided pronunciation units (S400);
calculating tone data for each video frame from the extracted representative tone data and assigning a letter attribute to each video frame (S500); and
playing back the video frame having the letter attribute assigned thereto as a video (S600),
wherein the dividing of the letter sequence into the pronunciation units is performed according to the method of claim 4.
